(19) United States
(12) Patent Application Publication
(10) Pub. No.: US 2012/0159084 A1
(43) Pub. Date: Jun. 21, 2012

(54) METHOD AND APPARATUS FOR REDUCING LIVELOCK IN A SHARED MEMORY SYSTEM

(76) Inventors: MARTIN T. POHLACK, Dresden (DE); Michael P. Hohmuth, Dresden (DE); Stephan Diestelhorst, Dresden (DE); David S. Christie, Austin, TX (US); JaeWoong Chung, Bellevue, WA (US)

(21) Appl. No.: 12/974,171

(22) Filed: Dec. 21, 2010

(51) Int. Cl. G06F 9/30; G06F 12/08

(52) U.S. Cl. 711/141; 712/216; 711/E12.017; 712/E09.028

(57) ABSTRACT

A method is provided for identifying a first portion of a computer program for speculative execution by a first processor element. At least one memory object is declared as being protected during the speculative execution. Thereafter, if a first signal is received indicating that the at least one protected memory object is to be accessed by a second processor element, then delivery of the first signal is delayed for a preselected duration of time to potentially allow the speculative execution to complete. The speculative execution of the first portion of the computer program may be aborted in response to receiving the delayed first signal before the speculative execution of the first portion of the computer program has been completed.

### CROSS-REFERENCE TO RELATED APPLICATIONS

Not applicable.

### BACKGROUND

The disclosed subject matter relates generally to shared memory in a multiprocessor environment, and, more particularly, to a method and apparatus for reducing instances of livelock in a shared memory system with transactional memory support.

In computer science, deadlock refers to a specific condition when two or more processes are each waiting for the other to release a resource. Deadlock is a common problem in multiprocessing environments where multiple processes share a specific type of mutually exclusive resource, such as a shared memory. For example, assume that process P1 has a lock on memory location M1 and has requested a lock on memory location M2. Also assume that at the same time, process P2 has a lock on memory location M2 and has requested a lock on memory location M1. Thus, each process needs access to a memory location controlled by the other process before either process can complete. Accordingly, neither process P1 or P2 can progress, and a deadlock exists.

Transactional memory is a new programming model that reduces or eliminates deadlock issues by not exposing the deadlock problem to programmers. Transactional memory allows software to declare speculative regions that specify and modify a set of protected memory locations. Modifications made to protected memory become visible either all at once (when the speculative region finishes successfully) or never (if the speculative region is aborted). Multiple speculative regions may access the same memory locations at the same time, which may lead to a temporary deadlock situation in the underlying implementation of the transactional memory. These deadlocks may be resolved by aborting the speculative region and by notifying software, which can retry the operation as desired.

Unfortunately, one undesirable side effect of a system that employs transactional memory is a condition commonly called livelock. Livelock is similar to a deadlock, except that the states of the processes involved in livelock constantly change with regard to one another. Thus, both processes continue to take action, but neither progresses. A real-world example of livelock occurs when two people meet in a narrow corridor, and each tries to be polite by moving aside to let the other pass, but they end up swaying from side to side without making any progress because they both repeatedly move the same way at the same time. A similar situation can occur using transactional memory. For example, assume processor A is executing a speculative region A when processor B begins executing a speculative region B that also intends to access some of the same memory locations currently identified in the speculative region A. Processor A immediately aborts speculative region A and returns any changed memory locations to their previous value. Processor B continues to execute speculative region B. If processor A immediately retries to execute speculative region A, processor B will detect a conflict and abort speculative region B. The process will continue unabated with each speculative region causing the other to abort. Thus, neither speculative region progresses and a livelock exists.

### BRIEF SUMMARY OF EMBODIMENTS

The following presents a simplified summary of the disclosed subject matter in order to provide a basic understanding of some aspects of the disclosed subject matter. This summary is not an exhaustive overview of the disclosed subject matter. It is not intended to identify key or speculative elements of the disclosed subject matter or to delineate the scope of the disclosed subject matter. Its sole purpose is to present some concepts in a simplified form as a prelude to the more detailed description that is discussed later.

One aspect of the disclosed subject matter is seen in a method that comprises identifying a first portion of a computer program for speculative execution by a first processor element; declaring at least one memory object as being protected during the speculative execution; receiving a first signal indicating that the at least one protected memory object is to be accessed by a second processor element; delaying delivery of the first signal for a duration of time; and aborting the speculative execution of the first portion of the computer program in response to receiving the delayed first signal before the speculative execution of the first portion of the computer program has been completed.

Another aspect of the disclosed subject matter is seen in a computer readable program storage device encoded with at least one instruction that, when executed by a computer, performs a method that comprises identifying a first portion of a computer program for speculative execution by a first processor element; declaring at least one memory object as being protected during the speculative execution; receiving a first signal indicating that the at least one protected memory object is to be accessed by a second processor element; delaying delivery of the first signal for a preselected duration of time; and aborting the speculative execution of the first portion of the computer program in response to receiving the delayed first signal before the speculative execution of the first portion of the computer program has been completed.

Another aspect of the disclosed subject matter is seen in a method that comprises identifying a first portion of a computer program for speculative execution by a first processor element; declaring at least one memory object as being protected during the speculative execution; receiving a first signal indicating that the at least one protected memory object is to be accessed by a second processor element; sending an acknowledgement signal to the second processor element in response to receiving the first signal; and aborting the speculative execution of the first portion of the computer program in response to receiving a second signal indicating that the at least one protected memory object is to be accessed by the second processor element before the speculative execution of the first portion of the computer program has been completed.

### BRIEF DESCRIPTION OF THE SEVERAL VIEWS OF THE DRAWINGS

The disclosed subject matter will hereafter be described with reference to the accompanying drawings, wherein like reference numerals denote like elements, and:

FIG. 1 is a block level diagram of a processor interfaced with external memory;

FIG. 2 is a simplified block diagram of a dual-core module that is part of the processor of FIG. 1;

FIG. 3 is a stylistic block diagram and flow chart regarding the operation of a shared cache that is part of the processor of FIG. 1;

FIG. 4 is a stylistic block diagram and flow chart regarding the operation of a delay that is part of the processor of FIG. 1;

FIG. 5 is an alternative embodiment of a stylistic block diagram and flow chart regarding the operation of and interaction between a cache and core that are part of the processor of FIGS. 1; and

FIG. 6 is an alternative embodiment of a stylistic block diagram and flow chart regarding the operation of and interaction between a core and a cache that are part of the processor of FIG. 1.

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the spirit and scope of the disclosed subject matter as defined by the appended claims.

### DETAILED DESCRIPTION OF EMBODIMENTS

One or more specific embodiments of the disclosed subject matter will be described below. It is specifically intended that the disclosed subject matter not be limited to the embodiments and illustrations contained herein, but include modified forms of those embodiments including portions of the embodiments and combinations of elements of different embodiments as come within the scope of the following claims. It should be appreciated that in the development of any such actual implementation, as in any engineering or design project, numerous implementation-specific decisions may be made to achieve the developers' specific goals, such as compliance with system-related and business related constraints, which may vary from one implementation to another. Moreover, it should be appreciated that such a development effort might be complex and time consuming, but may nevertheless be a routine undertaking of design, fabrication, and manufacture for those of ordinary skill having the benefit of this disclosure. Nothing in this application is considered speculative or essential to the disclosed subject matter unless explicitly indicated as being “speculative” or “essential.”

The disclosed subject matter will now be described with reference to the attached figures. Various structures, systems and devices are schematically depicted In the drawings for purposes of explanation only and so as to not obscure the disclosed subject matter with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

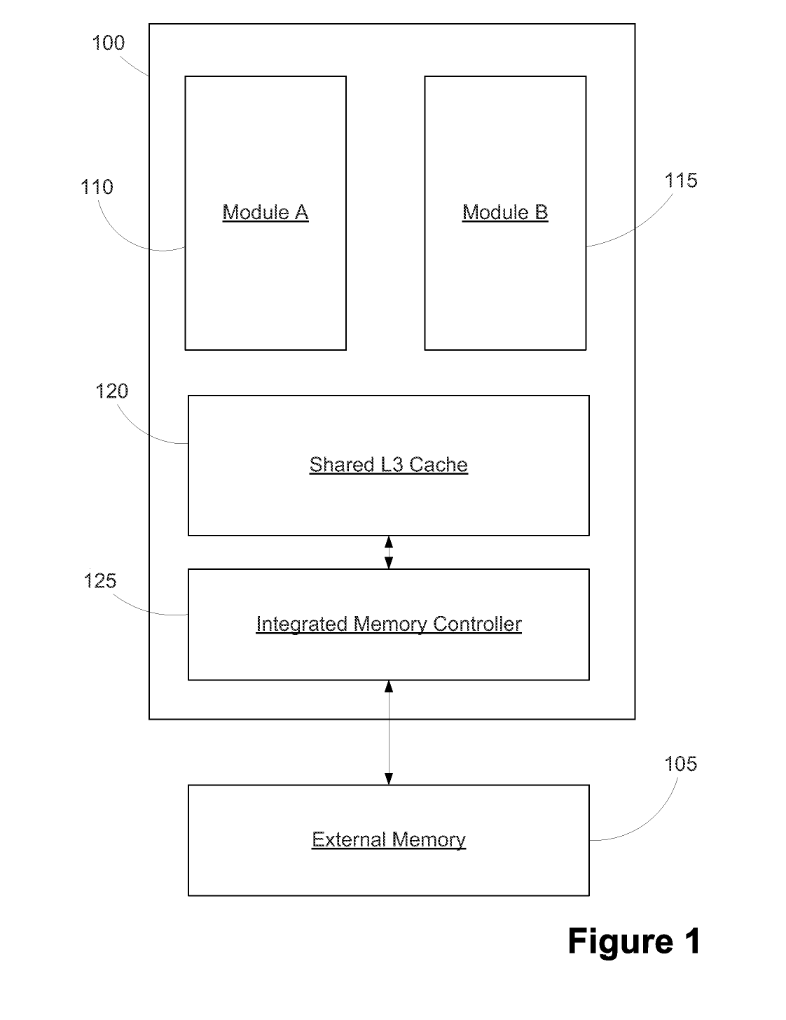

Referring now to the drawings wherein like reference numbers correspond to similar components throughout the several views and, specifically, referring to FIG. 1, the disclosed subject matter shall be described in the context of a processor 100 coupled with an external memory 105. Those skilled in the art will recognize that a computer system may be constructed from these and other components. However, to avoid obfuscating the instant invention only those components useful to an understanding of the present invention are included.

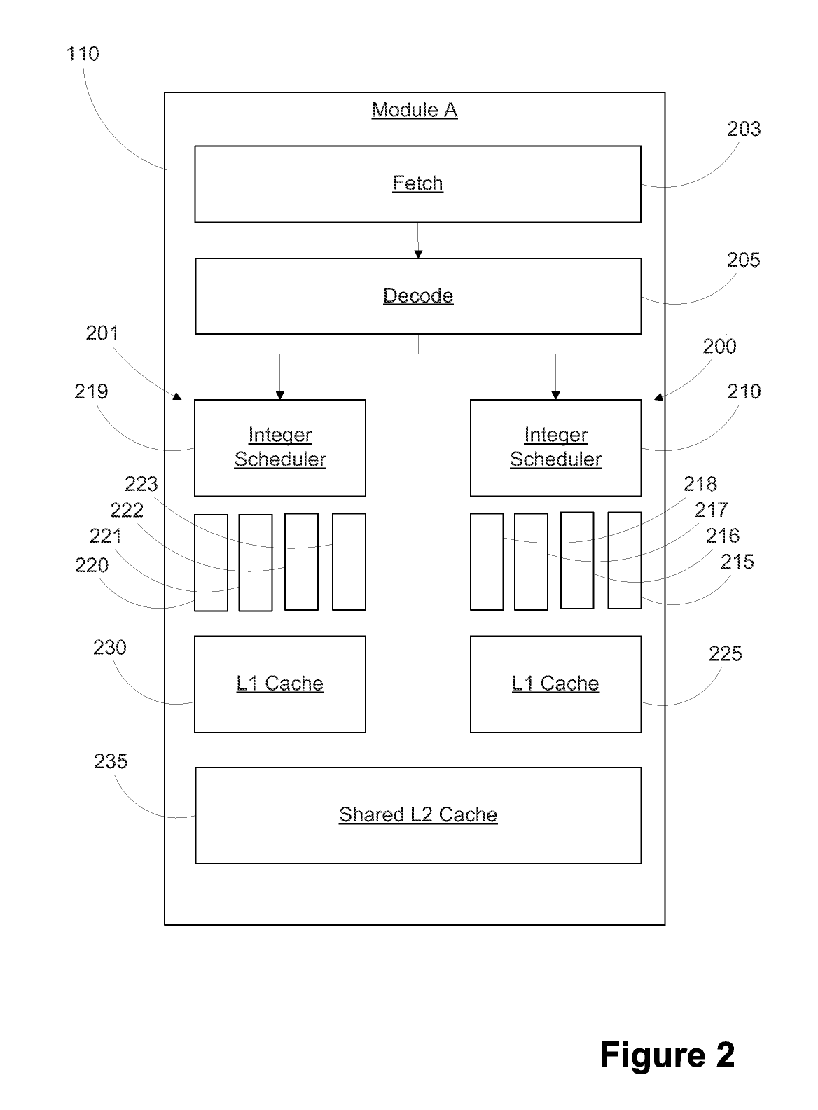

In one embodiment, the processor 100 employs a pair of substantially similar modules, module A 110 and module B 115. The modules 110, 115 are substantially similar and include processing capability (as discussed below in more detail in conjunction with FIG. 2). The modules 110, 115 engage In processing under the control of software, and thus access memory, such as external memory 105 and/or caches, such as a shared L3 cache 120 and/or internal caches (discussed in more detail below in conjunction with FIG. 2). An integrated memory controller 125 is included within each of the modules 110, 115. The integrated memory controller 125 generally operates to interface the modules 110, 115 with the conventional external semiconductor memory 105. Those skilled in the art will appreciate that each of the modules 110, 115 may include additional circuitry for performing other useful tasks,

Turning now to FIG. 2, a block diagram representing the internal circuitry of either of the modules 110, 115 is shown. Generally, the modules 110, 115 consist of two processor cores 200, 201 that include both individual components and shared components. For example, the module 110 includes shared fetch and decode circuitry 203, 205, as well as an L2 cache 235. Both of the cores 200, 201 have access to and utilize these shared components.

The processor core 200 also includes components that are exclusive to it. For example, the processor core 200 includes an integer scheduler 210, four substantially similar, parallel pipelines 215, 216, 217, 218, and an L1 Data Cache 225. Likewise, the processor core 201 includes an integer scheduler 219, four substantially similar, parallel pipelines 220, 221, 222, 223, and an L1 Data Cache 230.

The operation of the module 110 involves the fetch circuitry 203 retrieving instructions from memory, and the decode circuitry 205 operating to decode the instructions so that they may be executed on one of the available pipelines 215-218, 220-223. Generally, the integer schedulers 210, 219 operate to assign the decoded instructions to the various pipelines 215-218, 220-223 where they are executed. During the execution of the instructions, the pipelines 215-218, 220-223 may access the corresponding L1 Caches 225, 230, the shared L2 Cache 235, the shared L3 cache 120 and/or the external memory 105.

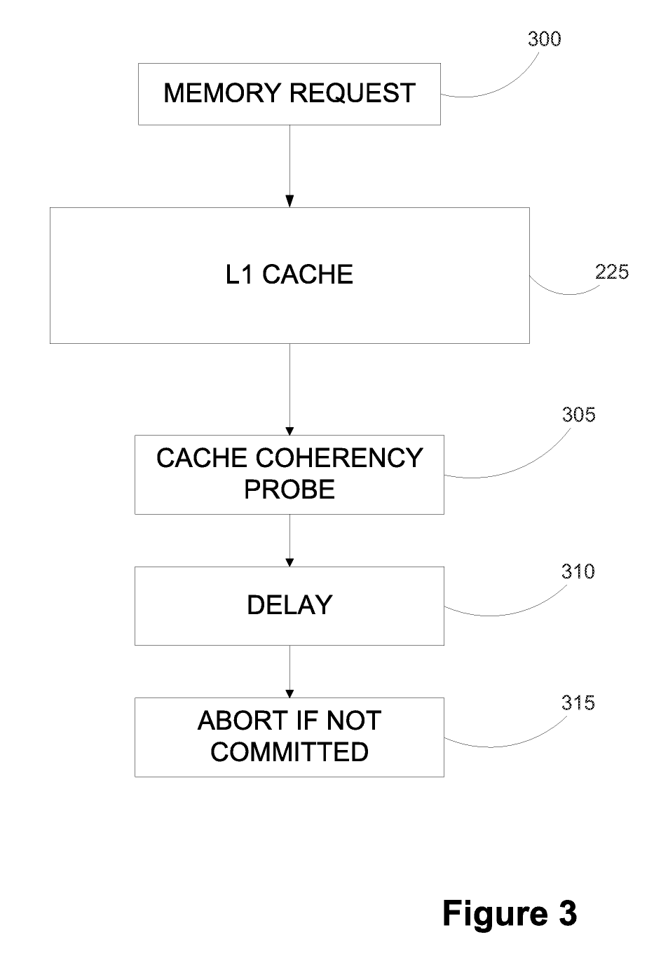

Turning now to FIG. 3, the operation of the L1 Caches 225, 230 will next be discussed in greater detail, as they interface with the cores 200, 201, for purposes of implementing features of the instant invention. In particular, the L1 caches 225, 230 issue probe signals to determine if a particular line in the cache 225, 230 is present in another cache 225, 230, 235, 120, so as to provide a coherent view of system memory. Generally, the L1 cache 225 stores selected portions, such as lines, of the L2 cache 235, the L3 cache 120 or the external memory 105 and makes them available to the core 200 at a higher speed than they would otherwise be available from the higher level memory. Likewise, the L1 cache 230 stores selected portions, such as lines, of the L2 cache 235, the L3 cache 120 or the external memory 105 and makes them available to the core 200 at a higher speed than they would otherwise be available from the higher level memory. Both the cache 225 and the cache 230 may have the same line of external memory stored therein such that separate processes being executed by the cores 200, 201 may attempt to access the same line of memory, creating a potential conflict.

As shown in FIG. 3, when a process being executed by the core 200 attempts to access a memory location that is not in the L1 cache 225, or attempts to write a location in the L1 cache 225 for which it has not been granted exclusive access by the cache coherency protocol, by issuing a memory request 300, a cache coherency probe signal 305 is issued and is conveyed to the core 201. In one embodiment of the instant invention, the cache coherency probe signal 305 may be issued by a memory controller on behalf of the core 200 making the request. The core 201 receives the cache coherency probe 305 and compares it to the memory locations that it is currently accessing or waiting to access. If there is a match, indicating that a process being executed by the core 200 is attempting to access the same line of memory being accessed by the core 201 in an atomic memory access, then the atomic memory access in the core 201 is aborted.

AMD's Advanced Synchronization Facility (ASF) is an AMD64 extension to allow user-level and system-level code to modify a set of memory objects atomically without requiring expensive traditional synchronization mechanisms. The ASF extension provides an inexpensive primitive from which higher-level synchronization mechanisms can be synthesized: for example, multi-word compare-and-exchange, load-locked-store-conditional, lock-free data structures, lock-based data structures that do not suffer from priority inversion, and primitives for software-transactional memory. ASF has advantages over existing atomic memory modification primitives. Instead of offering new instructions with hardwired semantics (such as compare-and-exchange for two independent memory locations), ASF only exposes a mechanism for atomically updating multiple independent memory locations and allows software to implement the intended synchronization semantics.

ASF allows software to declare speculative sections that specify and modify a set of protected memory locations. Modifications made to protected memory by one of the cores (e.g.; core 200) becomes visible to the other core 201 either all at once (when the speculative section finishes successfully) or never (if the speculative section is aborted). In one embodiment of the instant invention, a cache coherency protocol is used for detecting contention for a protected memory location. That is, the cache coherency protocol can be used to detect conflicting memory accesses and abort the speculative section, as discussed above in conjunction with FIG. 3.

ASF speculative sections do not require mutual exclusion. Multiple ASF speculative sections that may access the same memory locations can be active at the same time on different processors (such as the cores 200, 201), allowing greater parallelism. When ASF detects conflicting accesses to protected memory, it aborts the speculative section and notifies the software, which can retry the operation as desired.

ASF uses a set of instructions for denoting the beginning and ending of a speculative section and for protecting memory objects. Additionally, ASF speculative sections first specify which memory objects are to be protected using special declarator instructions.

Once a set of memory objects have been declared as protected, a speculative section can modify these memory objects speculatively. If a speculative section completes successfully, all such modifications become visible to all of the cores 200, 201 simultaneously and atomically. Otherwise, the modifications are discarded.

An ASF speculative section has the following structure:
1. The speculative section is entered with a SPECULATE instruction.
2. The SPECULATE instruction writes an ASF status code of zero in rAX and sets rFLAGS register accordingly. This status code distinguishes between the initial entry into a speculative section and an abort situation. The SPECULATE instruction also records the address of the instruction following the SPECULATE instruction as the landmark to which control is transferred on an abort.
3. The SPECULATE instruction is followed by instructions that check the status code and jump to an error handler if it is not zero (e.g., JNZ).
4. Declarator instructions (memory-load forms of LOCK MOVx, LOCK PREFETCH, and LOCK PREFETCHW instructions) are used to specify locations for atomic access—memory that ASF is to protect. The MOV forms also perform the specified register load.
5. The speculative section (standard x86 instructions) is executed (items 4 and 5 can be mixed relatively arbitrarily, as declarators can occur anywhere within speculative regions).
6. Once a memory location has been protected using a declarator instruction, it can be read using regular x86 instructions. However, to modify protected memory locations, the speculative section uses memory-store forms of LOCK MOVx instructions. (an error will occur if regular memory updating instructions are used for protected memory locations. Doing so results in a #GP exception.)
7. A COMMIT instruction denotes the end of the speculative section and causes the modifications to the protected lines to become visible to the rest of the system.
8. An ABORT instruction is available to programmatically terminate the speculative section with ABORT rather than COMMIT semantics.

In the illustrated embodiment, ASF protects memory lines that have been specified using the declarator instructions, such as LOCK MOVx, LOCK PREFETCH, and LOCK PREFETCHW. In the illustrated embodiment, all other memory remains unprotected and can be modified inside a speculative section using standard x86 instructions. These modifications become visible to each of the cores 200, 201 immediately, in program order.

In one embodiment, Declarator instructions are memory-reference instructions that are used to specify locations for which atomic access is desired. Declarator instructions work like their counterparts without the LOCK prefix, with the following additional operation: each declarator instruction adds the memory line containing the first byte of the referenced memory object to the set of protected lines. Software checks to determine if unaligned memory accesses span both protected and unprotected lines (or otherwise takes steps to ensure they will not); otherwise, the atomicity of data accesses to these memory objects is not guaranteed.

Unlike prefetch instructions without a LOCK prefix, LOCK PREFETCH and LOCK PREFETCHW instructions also check the specified memory address for translation faults and memory-access permission (read or write, respectively) and, if unsuccessful, generate a page-fault or general-protection exception as appropriate. Also, LOCK PREFETCH and LOCK PREFETCHW instructions generate a #DB exception when they reference a memory address for which a data breakpoint has been configured.

A declarator instruction referencing a line that has already been protected is permitted and behaves like a regular memory reference. It does not change the protected status of the line. The line remains protected.

A contention is interference that other processors/cores 200, 201 cause when they access memory that has been protected by a declarator instruction. ASF aborts speculative sections under certain types of contention. The following table summarizes how ASF handles contention in the case where the Core 201 performs an operation while the Core 200 is in a speculative section with the line protected by ASF.

TABLE I

| | | Core 200 Cache-line State | |
|---|---|---|---|
| Core 201 | | Protected | Protected |
| Mode | Core 201 Operation | Shared | Owned* |
| Speculative | LOCK MOVx (load) | OK | aborts |
| section | | | |
| Speculative | LOCK MOVx (store) | aborts | aborts |
| section | | | |
| Speculative | LOCK PREFETCH | OK | aborts |
| section | | | |
| Speculative | LOCK PREFETCHW | aborts | aborts |
| section | | | |
| Speculative | COMMIT | OK | OK |
| section | | | |
| Any | Read operation | OK | aborts |
| Any | Write operation | aborts | aborts |
| Any | Prefetch operation | OK | aborts |
| Any | PREFETCHW | aborts | aborts |

*Owned—Modified or Owned

To reduce instances of livelock, it may be useful to delay a response to the cache coherency probe 305. For example, assume that a first ASF speculative section is being executed by the core 201 and is nearly complete when the core 200 begins to execute a second ASF speculative section, which causes the L1 cache 225 to issue the cache coherency probe 305 to the core 201. If a short delay 310 is introduced before the core 201 honors the cache coherency probe, then the first ASF speculative section being performed by the core 201 may naturally complete and commit, rather than be aborted, without unduly delaying the second ASF speculative section. If the first ASF speculative section has not committed by the time the delay 310 expires, then the first ASF speculative section is aborted at 315.

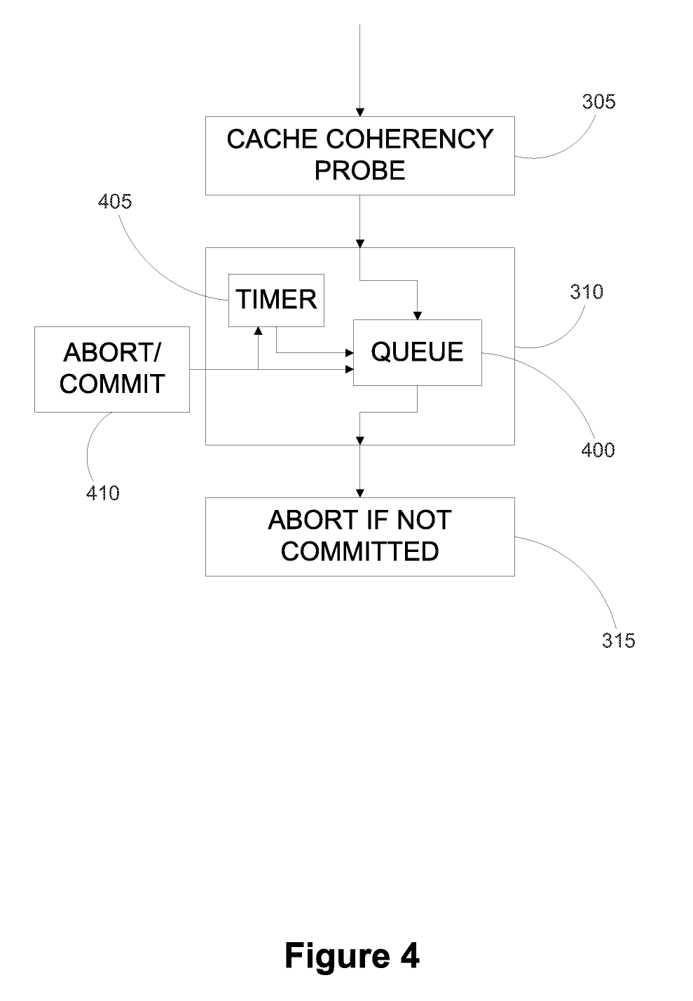

In one embodiment, it may be useful to utilize a timed queue to receive the cache coherency probe 305 (and any other cache coherency probes that are issued during the delay period). Turning to FIG. 4, the cache coherency probe 305 may be delivered to a queue 400 where it is held until one of several events occurs. First, a timer 405 may be started when the cache coherency probe is stored in the queue 400. If the first ASF speculative section completes (either by committing or by being aborted), then an abort/commit signal 410 is delivered to the queue 400, causing the queue 400 to release the cache coherency probe(s) 305 stored therein, which is (are) then honored by the core 200, 201. Additionally, the abort/commit signal 410 may also be delivered to the timer 405 to reset its operation. In this scenario, the delay 310 has successfully allowed the first ASF speculative section to complete without being unnaturally terminated by the cache coherency probe 305.

On the other hand, if the delay 310 has been insufficient to allow the first ASF speculative section to complete, the timer 405 will time out and issue a signal to the queue 400 that causes the queue 400 to deliver a cache coherency probe 305 that aborts the first ASF speculative section. In one embodiment, the cache coherency probe response may take the form of a dedicated error code. The core 201 recognizes the error code and responds by causing the ASF speculative region to be aborted such that all modifications to the memory locations referenced in the first ASF speculative region are discarded.

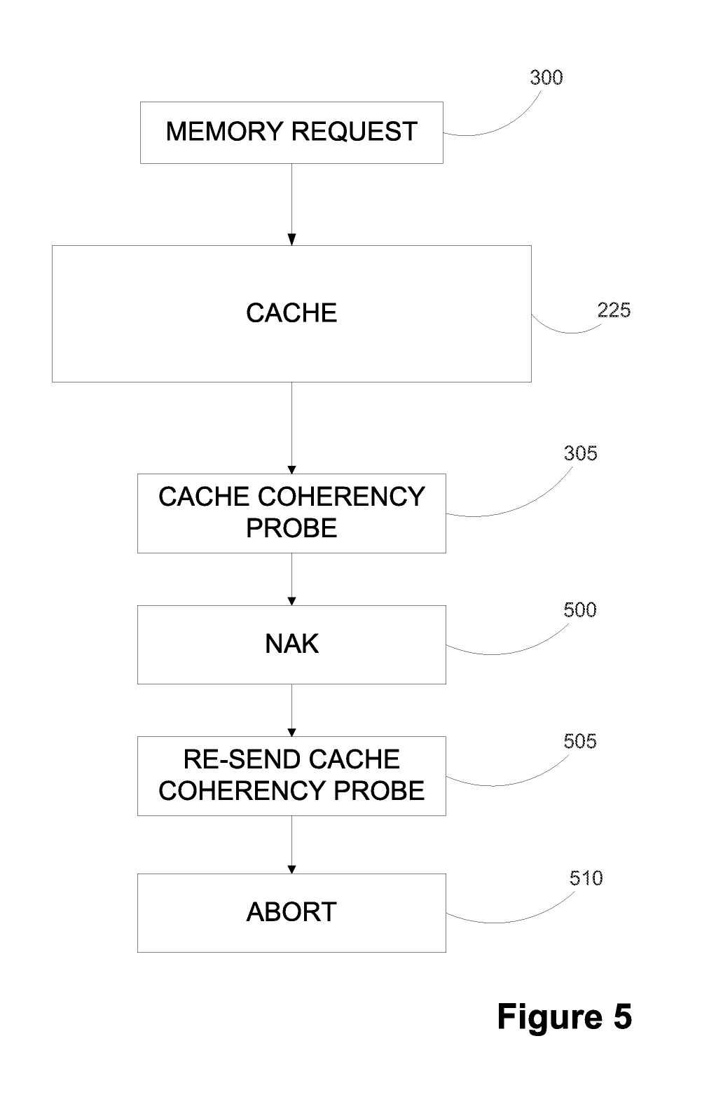

An alternative embodiment that also reduces instances of livelock is shown in FIG. 5. In this embodiment, when the cache coherency probe 305 is received by the core 201, it sends an acknowledgment signal (e.g., NAK) 500 to the originator, such as the L1 cache 225. The L1 cache 225 then re-sends the cache coherency probe 505 at a later time, which may be sufficient to allow the first ASF speculative region to complete and commit. In one embodiment, the NAK 500 may include an indication of when to re-send the cache coherency probe 505.

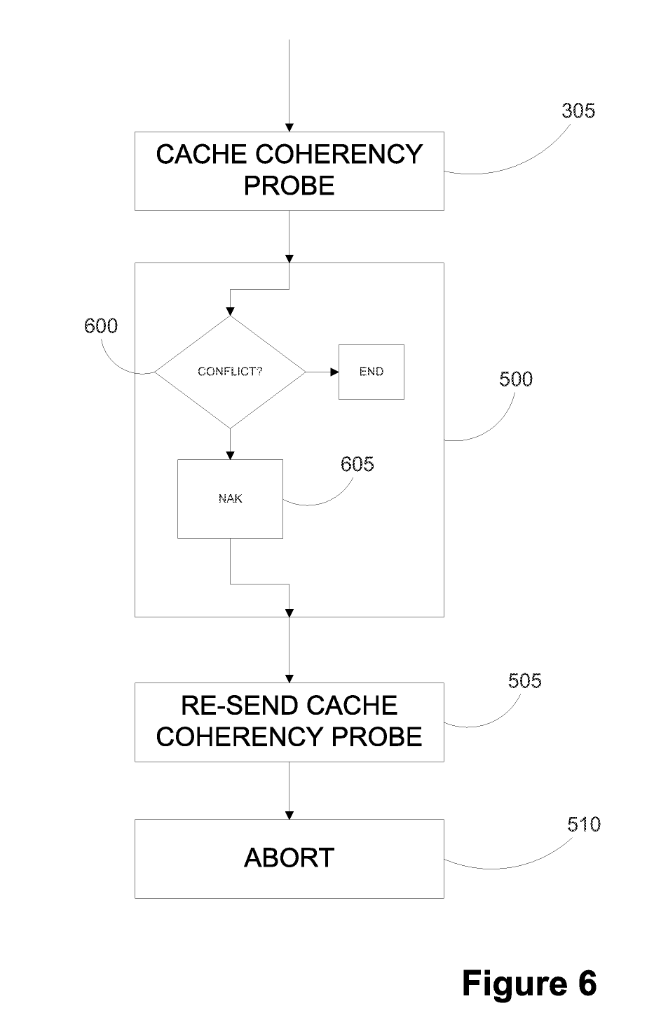

Those skilled in the art will appreciate that it may be useful for the L1 cache 225 to reseed the cache coherency probe 505 only when a conflict is detected by the core 201. That is, as shown in FIG. 6, the core 201 compares the cache coherency probe 305 to the memory locations in the first ASF speculative region, and if a conflict 600 exists, the NAK 605 is sent to the L1 cache 225, indicating that the L1 cache 225 should re-send the cache coherency probe 305 at a later time. On the other hand, if no conflict exists, then the core 201 does not send a NAK.

In an alternative embodiment of the instant invention, it may be useful to extend the principals discussed above to also reduce instances of deadlock. In particular, those skilled in the art will appreciate that the technique described above operates to convert a livelock situation into a potential deadlock situation. Performance of the cores 200, 201 may be further enhanced by reducing the instances of deadlock, that may arise from the conversion of the livelock situations into potential deadlock situations. In particular, performance of the cores 200, 201 may be enhanced by dynamically reordering independent memory accesses by the cores 200, 201.

There are four necessary preconditions to a deadlock situation, and thus it is possible to prevent a deadlock by breaking any one of these preconditions. Two of these preconditions that may result in a deadlock situation are: 1) a hold and wait condition where at least two resources are involved); and 2) a circular wait condition.

A first methodology that may be utilized to circumvent a deadlock that arises from the circular wait condition is to establish a total order over the involved resources and to use this order for requesting resources. In this manner, no circular wait conditions can be formed, which will inhibit the second precondition.

A second methodology that may be utilized to circumvent a deadlock that arises from the hold and wait condition is to request all resources in one atomic step. However, to request all resources in one atomic step, all resources have to be known at one time. In these cases, the ordering approach may also be applied (if a total order over resource can be established altogether).

Those skilled in the art will appreciate that these methodologies may not be universally applicable, as there are some scenarios in which resources cannot be allocated according to their order. For example, in some scenarios, the exact resource set may only be known after some resources have been acquired. This may also be true with respect to memory references that are not independent of each other. Therefore, those skilled in the art will appreciate that the first and second methodologies are useful to reduce instances of livelock/deadlock, but not to fully eliminate the issue. Nevertheless, such improvements in handling the livelock/deadlock issue may still produce enhanced performance of the cores 200, 201.

The general principles discussed above regarding the first and second methodologies are now discussed in greater detail with respect to a specific application, AMD's ASF. Resources are requested by executing an ASF declarator instruction for an address in a memory line (e.g., LOCK MOV). It is anticipated that any of a plurality of different orders may be implemented regarding accesses to memory. For exemplary purposes only, three possible orders are described herein: 1) physical addresses; 2) virtual addresses; and 3) application specific ordering.

There is a natural order for memory lines—their physical addresses. Physical addresses are natural, perfect and global with respect to all processes being executed by the cores 200, 201. Memory requests may be rounded to their resource address, which corresponds to their memory line (e.g. “LOCK MOV rax, byte ptr [3]” and “LOCK MOV rax, dword ptr [2]” have the same order. Unaligned accesses, which span two lines, request both in order (e.g., “LOCK MOV rax, dword ptr [64-2]” requests memory line 0 and 1 in that order assuming memory lines are 64 byte wide),

If physical addresses cannot be used (e.g., because of implementation specific reasons), virtual addresses may also be useful as an order criteria. Addresses within one page are still ordered, which in many instances is sufficient to protect access to smaller data structures, and threads within one address space mostly see the same virtual-to-physical address mapping (aliasing and CPU-local mappings ignored). Although the order established via virtual addresses is not perfect it is sufficient in many instances to reduce livelock for many applications. Moreover, user-space software, such as classical compilers and linkers or just-in-rime compilers, may work much more easily with virtual addresses, as the virtual-to-physical address mapping may not be known at their runtime.

Additionally, application specific ordering may be a desirable ordering scheme in some applications. For example, linked lists and other similar structures have a natural order (i.e., the list order). Likewise, for tree-like data structures a similar property is true if resource allocation generally follows a specific pattern (i.e., root-to-leaf or leaf-to-root).

The example shown in Table II demonstrates a locking situation that occurs because the resources are not requested in a specified order (res1 and res2 are requested in different order).

TABLE II

| Thread 1 | Thread 2 |
|---|---|
| 01 speculate | 01 speculate |
| . . . | . . . |
| 03 lock mov [res1], rax | 03 lock mov [res2], rax |
| . . . | . . . |
| 05 lock mov [res2], rbx | 05 lock mov [res1], rbx |
| . . . | . . . |
| 08 commit | 08 commit |

I f bot h Thr cad 1 and Thread 2 execute exactly simultaneously, they will abort each other at line 05, if the cache coherency probe cannot be delayed. However, even with the delayed cache coherency probe, Thread 1 and Thread 2 will still deadlock each other at line 05. On the other hand, if reordering is implemented, then Thread 2 reorders the execution of line 05 and line 03 such that line 05 is retired first. The cache coherency probe for res1 is delayed by Thread 1 until Thread 1 executes “commit” in line 8.

In instances where no total order can be established over all resources, the potentially occurring deadlocks can be reduced by using a timeout for delayed cache coherency probes or by detecting this situation dynamically by applying an alternative discussed in more detail below.

In one embodiment, hardware is allowed to reorder independent, speculative memory accesses to reduce the chance of such deadlocks. However, software can also accomplish the reordering for accesses for address pairs with compile-time known values (e.g., first vs. third member of a C struct). In such a software reordering embodiment, it may be useful to utilize virtual addresses as the ordering criteria, as discussed above.

Those skilled in the art will appreciate that runtime-determined address reordering may benefit from a special version of, e.g., DCAS (double compare-and-swap), where the caller reorders parameters, or DCAS takes two internal paths etc.

In an alternative embodiment, it may be useful to employ a dedicated version of the SPECULATE instruction to signal that all speculative requests within the speculative section are ordered (according to some order) and that therefore delaying cache coherency probes is safe (will not lead to a deadlock). The dedicated SPECULATE instruction signals to the cores 200, 201 that software cares for ordering (which works for a specific class of problems) and that the chance for deadlock is insignificant. In some embodiments, it may be useful for each set of speculative regions that may interfere with each other to use a consistent order.

In this embodiment, actual deadlocks can still be intercepted with timeouts on the cache coherency probe delays, which would result in an abort of the local speculative region. This abort may include a dedicated return value informing software of the nature of the problem.

In an alternative embodiment, it may be useful to delay probes only if speculative accesses are in order. Instead of doing the ordering in hardware, it may be useful to include software, hardware or firmware that is capable of determining whether the current speculative region's requests for protected memory locations are already in order (e.g., as a matter of coincidence, because order was enforced by a compiler etc., or by reordering hardware). The cores 200, 201 are allowed to delay cache coherency probes for successfully protected cache lines only if the local ordering property (described more fully below) holds for a speculative region.

In one embodiment, all requests for protected memory are “in order” if the temporal sequence of memory lines locked in the core's cache is ordered by the memory lines' physical addresses. Alternatively, the virtual address order may also be used. The core implementation needs to make sure that this locking sequence corresponds to the reordered program's instruction sequence (for example by locking the line [and thereby disabling probe responses] in the retirement stage of declarator instructions).

The probe order generated by the core 200, or seen by the core 201, is insignificant. One advantage of this embodiment is that the protocol works even if prefetched cache lines arrive out of order.

In the described embodiment, deadlock can occur only if a core does not respond to a probe for a locked line while waiting for another probe response for a line in a circular dependency chain (unless the probe-response delay times out).

Those skilled in the art will appreciate that in this illustrated embodiment, circular dependency chains can occur when the core 200 holding a locked line depends on a probe response for another line from the core 201 that in turn has a (direct or indirect) dependency on the core 200. However, at least one of the cores 200, 201 in the circular dependency chain is not allowed to delay probes because its requests have occurred out of order (otherwise there would be no circular dependency). Thus circular chain waits cannot occur in the illustrated embodiment.

Speculative regions requesting their protected memory lines in physical-address order prevent other cores that access these lines from making forward progress, including other cores running speculative regions that also maintain the local ordering property. If two such speculative regions X and Y share a memory line A, the one that locks the shared memory line first (X) prevents the other (Y) from making progress beyond that point because Y's probe will be delayed. Even if the blocked speculative region Y prefetched another shared line B, X can later fetch line B again and lock it. This is possible because Y cannot lock B before it has locked A. In the absence of delayed cache coherency probes, these cache-line fetches would abort the other speculative region X and potentially lead to livelock. With delayed probes, there is no abort, and hence less opportunity for livelock.

It is also contemplated that, in some embodiments, different kinds of hardware descriptive languages (HDL) may be used in the process of designing and manufacturing very large scale integration circuits (VLSI circuits) such as semiconductor products and devices and/or other types semiconductor devices. Some examples of HDL are VHDL and Verilog/Verilog-XL, but other HDL formats not listed may be used. In one embodiment, the HDL code (e.g., register transfer level (RTL) code/data) may be used to generate GDS data, GDSII data and the like. GDSII data, for example, is a descriptive file format and may be used in different embodiments to represent a three-dimensional model of a semiconductor product or device. Such models may be used by semiconductor manufacturing facilities to create semiconductor products and/or devices. The GDSII data may be stored as a database or other program storage structure. This data may also be stored on a computer readable storage device (e.g., data storage units 160, RAMs 130 & 155, compact discs, DVDs, solid state storage and the like). In one embodiment, the GDSII data (or other similar data) may be adapted to configure a manufacturing facility (e.g,. through the use of mask works) to create devices capable of embodying various aspects of the instant invention. In other words, in various embodiments, this GDSII data (or other similar data) may be programmed into a computer 100, processor 125/140 or controller, which may then control, in whole or part, the operation of a semiconductor manufacturing facility (or fab) to create semiconductor products and devices. For example, in one embodiment, silicon wafers containing an RSQ 304 may be created using the GOSH data (or other similar data).

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the disclosed subject matter. Accordingly, the protection sought herein is as set forth in the claims below.

We claim:

1. A method, comprising:
declaring at least one memory object as being protected during speculative execution of an instruction;
receiving a first signal indicating that the at least one protected memory object is to be accessed;
delaying delivery of the first signal for a duration of time; and
aborting the speculative execution of the instruction in response to receiving the delayed first signal before the speculative execution of the instruction has been completed.

2. A method, as set forth in claim 1, wherein receiving the first signal indicating that the at least one protected memory object is to be accessed further comprises receiving a cache coherency probe indicating that the at least one protected memory object is to be accessed.

3. A method, as set forth in claim 2, further comprising, removing the first signal from the queue in response to receiving an indication that the speculative execution of the instruction has completed before the preselected duration of time expired.

4. A method, as set forth in claim 3, wherein removing the first signal from the queue in response to receiving an indication that the speculative execution of the instruction has completed before the preselected duration of time expired further comprises, removing the first signal from the queue in response to receiving a signal indicating that the speculative execution of the instruction has been committed.

5. A method, as set forth in claim 1, wherein declaring the at least one memory object as being protected during the speculative execution of the instruction further comprises using at least one declarator instruction to identify the at least one memory object as being protected.

6. A method, as set forth in claim 1, wherein declaring at least one memory object as being protected during the speculative execution further comprises declaring a plurality of memory objects as being protected, establishing a total order over the plurality of memory objects and using the total order for accessing the plurality of memory objects.

7. A method, as set forth in claim 6, wherein the total order corresponds to addresses associated with each of the plurality of memory objects.

8. A method, as set forth in claim 6, wherein the total order corresponds to a physical address associated with each of the plurality of memory objects.

9. A method, as set forth in claim 6, wherein the total order corresponds to a virtual address associated with each of the plurality of memory objects.

10. A method, as set forth in claim 6, wherein the total order corresponds to a list order associated with each of the plurality of memory objects.

11. A method, as set forth in claim 6, wherein the total order corresponds to an application specific order associated with each of the plurality of memory objects.

12. A method, as set forth in claim 1, wherein declaring at least one memory object as being protected during the speculative execution further comprises declaring a plurality of memory objects as being protected, and preventing the delaying of the delivery of the first signal in response to determining that requests for the plurality of memory objects within the speculative region do not occur in a predetermined order.

13. A computer readable program storage device encoded with at least one instruction that, when executed by a computer, performs a method, comprising:
declaring at least one memory object as being protected during speculative execution of an instruction;
receiving a first signal indicating that the at least one protected memory object is to be accessed;
delaying delivery of the first signal for a duration of time; and
aborting the speculative execution of the instruction in response to receiving the delayed first signal before the speculative execution of the instruction has been completed.

14. A computer readable program storage device, as set forth in claim 13, wherein receiving the first signal indicating that the at least one protected memory object is to be accessed further comprises receiving a cache coherency probe indicating that the at least one protected memory object is to be accessed.

15. A computer readable program storage device, as set forth in claim 14, further comprising, removing the first signal from the queue in response to receiving an indication that the speculative execution of the instruction has completed before the preselected duration of time expired.

16. A computer readable program storage device, as set forth in claim 15, wherein removing the first signal from the queue in response to receiving an indication that the speculative execution of the instruction has completed before the preselected duration of time expired further comprises, removing the first signal from the queue in response to receiving a signal indicating that the speculative execution of the instruction has been committed.

17. A computer readable program storage device, as set forth in claim 13, wherein declaring the at least one memory object as being protected during the speculative execution of the instruction further comprises using at least one declarator instruction to identify the at least one memory object as being protected.

18. A computer readable program storage device, as set forth in claim 13, wherein declaring at least one memory object as being protected during the speculative execution further comprises declaring a plurality of memory objects as being protected, establishing a total order over the plurality of memory objects and using the total order for accessing the plurality of memory objects.

19. A computer readable program storage device, as set forth in claim 18, wherein the total order corresponds to addresses associated with each of the plurality of memory objects.

20. A computer readable program storage device, as set forth in claim 18, wherein the total order corresponds to a physical address associated with each of the plurality of memory objects.

21. A computer readable program storage device, as set forth in claim 18, wherein the total order corresponds to a virtual address associated with each of the plurality of memory objects.

22. A computer readable program storage device, as set forth in claim 18, wherein the total order corresponds to a list order associated with each of the plurality of memory objects.

23. A computer readable program storage device, as set forth in claim 18, wherein the total order corresponds to an application specific order associated with each of the plurality of memory objects.

24. A computer readable program storage device, as set forth in claim 18, wherein declaring at least one memory object as being protected during the speculative execution further comprises declaring a plurality of memory objects as being protected, and preventing the delaying of the delivery of the first signal in response to determining that requests for the plurality of memory objects within the speculative region do not occur in a predetermined order.

25. An apparatus, comprising:
A first processor element adapted to send a first signal indicating that at least one memory object is to be accessed;
a second processor element adapted to declare at least one memory object as being protected during speculative execution of an instruction, to receive the first signal, to delay responding to the first signal for a duration of time, and to abort the speculative execution of the instruction in response to the speculative execution of the instruction being incomplete at the end of the duration of time.

26. A computer readable storage device encoded with data that, when implemented in a manufacturing facility, adapts the manufacturing facility to create a processor adapted to perform a method, comprising:
declaring at least one memory object as being protected during speculative execution of an instruction;
receiving a first signal indicating that the at least one protected memory object is to be accessed;
delaying delivery of the first signal for a duration of time; and
aborting the speculative execution of the instruction in response to receiving the delayed first signal before the speculative execution of the instruction has been completed.
